(19) United States
(12) Patent Application Publication
(10) Pub. No.: US 2014/0347607 A1
(43) Pub. Date: Nov. 27, 2014

(54) Polarizing Device, Liquid Crystal Display Device and Manufacturing Method Thereof

(71) Applicant: Shenzhen China Star Optoelectronics Technology Co. Ltd., Shenzhen, Guangdong (CN)

(72) Inventors: Yong Zhao, Shenzhen City (CN); Dong Fu, Shenzhen City (CN); Xianwen Sun, Shenzhen City (CN)

(73) Assignee: Shenzhen China Star Optoelectronics Technology Co., Ltd., Shenzhen,Guangdong (CN)

(21) Appl. No.: 14/006,094

(22) PCT Filed: Jul. 1, 2013
(86) PCT No.: PCT/CN2013/078601

§ 371 Date: Sep. 18, 2013

(30) Foreign Application Priority Data
May 22, 2013 (CN) 2013101935825

(51) Int. Cl. G02F 1/1335; G02B 5/30

(52) U.S. Cl. CPC G02F 1/133528; G02B 5/305
USPC 349/96; 359/488.01; 156/60

(57) ABSTRACT

The present invention discloses a polarizing device, a liquid crystal display device and a manufacturing method thereof. The polarizing device comprises: a first support layer, a polarizing layer used to output linear polarized light, and a conversion layer with phase delay of m/4 wavelength. The m is an odd number larger than zero. The first support layer, the polarizing layer, and the conversion layer are staked sequentially. The angle θ between the optical axis of the conversion layer and the polarization axis of the polarizing layer are n*90°+45°, the n being an integer not less than zero. In this way, the present invention can change the polarization state of the emitted light of the liquid crystal display device without significantly increasing the cost of production, which can protect the human eye.

### BACKGROUND OF THE INVENTION

1. Field of the Invention

The present invention relates to the field of liquid crystal display, and in particular to a polarizing device, a liquid crystal display device and a manufacturing method thereof.

2. The Related Arts

With the development of liquid crystal technology, the liquid crystal display (LCD) device gradually becomes the mainstream of the electronics market because of its thin body, space saving, energy saving, low radiation, etc. For example, the current cell phones, notebook, camera, television, etc., are dominated by LCD.

The general LCD has the characteristic of the twisted nematic liquid crystal and the distortion characteristics of the developable and bendable. Each different distortion characteristics corresponds to the different display mode of the liquid crystal. However, the basic display principle corresponding to the different display mode is basically the same, all of which change the polarization direction of the light to display through the arrangement of the liquid crystal molecules. Wherein, the emitted lights of LCD are polarized light, the vibration direction of the light vector is fixed. The vector distribution of the natural light in each direction is uniform, which differs from the polarized light. Therefore, the stimulation of the natural light to the human eye photoreceptor cells is isotropic, so that people are more accustomed to natural light.

The current consumer spend more time on LCD which causes the consumers have eye irritation and other symptoms after using LCD for a long period.

### SUMMARY OF THE INVENTION

The technical issue to be solved by the present invention is to provide a polarizing device, a liquid crystal display device and a manufacturing method thereof, which can change the polarization state of the emitted light of LCD device with low costs and reduce the visual fatigue.

In order to solve the above issue, a technical solution adopted by the present invention is to provide a polarizing device, which comprises: a first support layer, a polarizing layer used to output linear polarized light, and a conversion layer with phase delay of m/4 wavelength, the m being an odd number larger than zero, the first support layer, the polarizing layer, and the conversion layer being staked sequentially, the angle θ between the optical axis of the conversion layer and the polarization axis of the polarizing layer being n*90°+45°, the n being an integer not less than zero, the conversion layer being as a second support layer at the same time cooperating with the first supporting layer to support the polarizing layer; the polarizing device further comprising a surface treatment layer used for anti-glare and anti-reflection, the surface treatment layer and the polarizing layer being provided on the both side surfaces of the conversion layer.

Wherein, the material of the conversion layer is one of cellulose triacetate, cycloolefin polymer, polyethylene terephthalate, polycarbonate, or poly methyl methacrylate.

Wherein, the material of the polarizing layer is polyvinyl alcohol.

Wherein, it further comprises a protective film, the protective film and the conversion layer are provided on the both side surfaces of the surface treatment layer.

Wherein it further comprises an adhesive layer and a release film, the adhesive layer is provided between the first support layer and the release film.

In order to solve the above technical issue, another technical solution adopted by the present invention is to provide a liquid crystal display device, which comprises: a liquid crystal cell and a polarizing device, the polarizing device being provided at the emitting light side of the liquid crystal cell, and the conversion layer being away from the liquid crystal cell corresponding to the polarizing layer, wherein, the polarizing device comprises: a first support layer, a polarizing layer used to output linear polarized light, and a conversion layer with phase delay of m/4 wavelength, the m being an odd number larger than zero, the first support layer, the polarizing layer, and the conversion layer being staked sequentially, the angle θ between the optical axis of the conversion layer and the polarization axis of the polarizing layer being n*90°+45°, the n being an integer not less than zero.

Wherein, the conversion layer is as a second support layer at the same time cooperating with the first supporting layer to support the polarizing layer.

Wherein, the material of the conversion layer is one of cellulose triacetate, cycloolefin polymer, polyethylene terephthalate, polycarbonate, or poly methyl methacrylate.

Wherein, the polarizing device further comprises a surface treatment layer used for anti-glare and anti-reflection, the surface treatment layer and the polarizing layer is provided on the both side surfaces of the conversion layer.

Wherein, the polarizing device further comprises an adhesive layer and a release film, the adhesive layer is provided between the first support layer and the release film.

Wherein, the emitting light side of the liquid crystal cell is further provided with a down polarizer.

In order to solve the above technical issue, the other technical solution adopted by the present invention is to provide a manufacturing method of polarizing device, which comprises: preparing a first support layer; pasting a polarizing layer used to output linear polarized light on the first support layer; pasting a conversion layer with phase delay of m/4 wavelength, the m being an odd number larger than zero, the angle θ between the optical axis of the conversion layer and the polarization axis of the polarizing layer being n*90°+45°, the n being an integer not less than zero.

Wherein, the conversion layer is cellulose triacetate layer, cycloolefin polymer layer, polyethylene terephthalate layer, polycarbonate layer, or poly methyl methacrylate layer after diagonally extending in odd multiple of 45°.

The benefits of the present invention are as follows. Differing from the situation of the prior art, the present invention provides a polarizing device using a conversion layer. Because the angle θ between the optical axis of the conversion layer and the polarization axis of the polarizing layer is n*90°+45°, wherein the n is an integer not less than zero, m is an angle larger than zero and smaller than 90°, it can transfer the linear polarized light of the polarizing device to a circularly polarized light or an elliptically polarized light. Through the above way, it is not necessary to provide a circularly polarized material with similar effect in addition to the existing polarizer, which can utilize the polarizing device to change the polarization state of the emitted light of LCD device with low costs, making it become the circularly polarized light or elliptically polarized light, and achieve the effect of protecting the human's eyes and simple structure. At the same time, the present embodiment doesn't need to provide the circularly polarized material with similar effect in addition to the existing polarizer. Therefore, the LCD product utilizing the polarizing device according to the present invention can keep the thin structure, and there is no requirement to provide the circularly polarized material with similar effect in addition to the existing polarizer which results the complex processes, reducing the cost,

### BRIEF DESCRIPTION OF THE DRAWINGS

FIG. 1 is a schematic structural diagram of he polarizer film according to the prior art;

FIG. 2 is a schematic structural diagram of the polarizing device according to an embodiment of the present invention;

FIG. 3 is a schematic diagram of the wavelength dispersion of the different materials:

FIG. 4 is a schematic structural diagram of the polarizing device according to another embodiment of the present invention;

FIG. 5 is a schematic structural diagram of the LCD device according to an embodiment of the present invention;

FIG. 6 is a flowchart of the manufacturing method of the polarizing device according to an embodiment of the present invention;

FIG. 7 is a schematic diagram of the bonding within the polarizing layer, the conversion layer and the first support layer according to the polarizing device manufacturing method of an embodiment of the present invention.

### DETAILED DESCRIPTION OF THE PREFERRED EMBODIMENTS

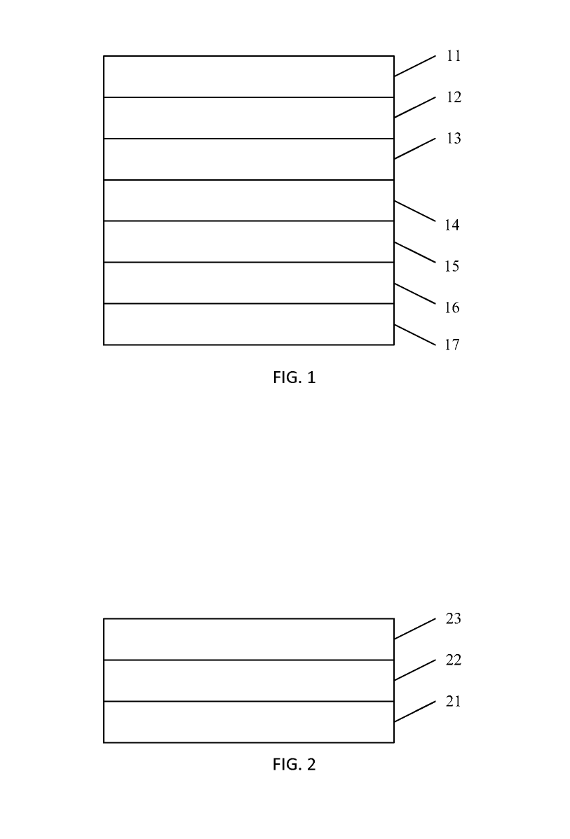

Polarizing film is an optical functional device made by bonding multilayer films. Referring to FIG. 1, the basic structure of the polarizing film comprises: a most middle of the polarizing layer 14, such as polyvinyl alcohol (PVA) layer, the polarizing layer 14 having polarization effect; inner and outer support layers 15, 13, the inner and outer support layers 15, 13 is typically selected from triacetyl cellulose (TAG), a cycloolefin polymer (COP), polyethylene terephthalate (PET), polycarbonate (PC), poly methyl methacrylate (PMMA), etc. according to the requirements; a PSA film 16, which is used to paste liquid crystal cell and polarizing film; a release film 17, which is used to protect the PSA film 16, and can be peeled off while pasting liquid crystal cell. In order to make the polarizing film have the functions of anti-glare and anti-reflection and increase the hardness, it usually has a surface treatment on the second support layer 13 to form an AG/AR layer 12. In order to protect the polarizing film, it also can provide a protective film 11 on the AG/AR layer 12, which can be peeled off during the module assembly.

The polarizing film used in the liquid crystal device is usually used in completely set, that is the upper polarizing film of the upper surface of the liquid crystal cell and the lower polarizing film of the lower surface of the liquid crystal cell.

The present invention provides a polarizing device in the purpose of transferring a linear polarized light output by the polarizing layer into a circular or an elliptical polarized light.

Referring to FIG. 2, FIG. 2 is a schematic structural diagram of the polarizing device according to an embodiment of the present invention. The polarizing device according to the present embodiment comprises a first support layer 21, a polarizing layer 22 used to output linear polarized light, and a conversion layer 23 with phase delay of m/4 wavelength. The m is an odd number larger than zero. Wherein, the first support layer 21, the polarizing layer 22, and the conversion layer 23 is staked sequentially. The angle between the optical axis of the conversion layer 23 and the polarization axis of the polarizing layer 22 is n*90°+45°. The n is an integer not less than zero. For example, the angle between the optical axis of the conversion layer 23 and the polarization axis of the polarizing layer 22 is 45° or 135°.

Wherein, the first support layer 21, the polarizing layer 22, and the conversion layer 23 are sequentially stacked. The conversion layer 23 is as the second support layer at the same time, in order to cooperate with the first support layer 21 to support the polarizing layer 22. Therefore, transfer the linearly polarized light output by the polarizing layer into the circular or the elliptical polarized light through the conversion layer 23, which achieves the support function and reduces the manufacturing costs of the polarizing device.

Wherein, the material of the conversion layer 23 is a material with phase delay of m/4 wavelength. The m is an odd number larger than zero, such as 1, 3, 5, etc. The material of the conversion layer 23 is selected from triacetyl cellulose (TAC), cycloolefin polymer (COP), polyethylene terephthalate (PET), polycarbonate (PC), or poly methyl methacrylate (PMMA). Wherein, it is preferably to utilize the TAC to be the material of the conversion layer 23, because the wavelength dispersion ratio thereof is closer to the ideal circularly polarizing film, which can obtain the emitted light closer to the state of the circular polarized light. The materials and the structures of the first support layer 21 and the inner support layer 15 of the polarizing film according to the prior art are the same.

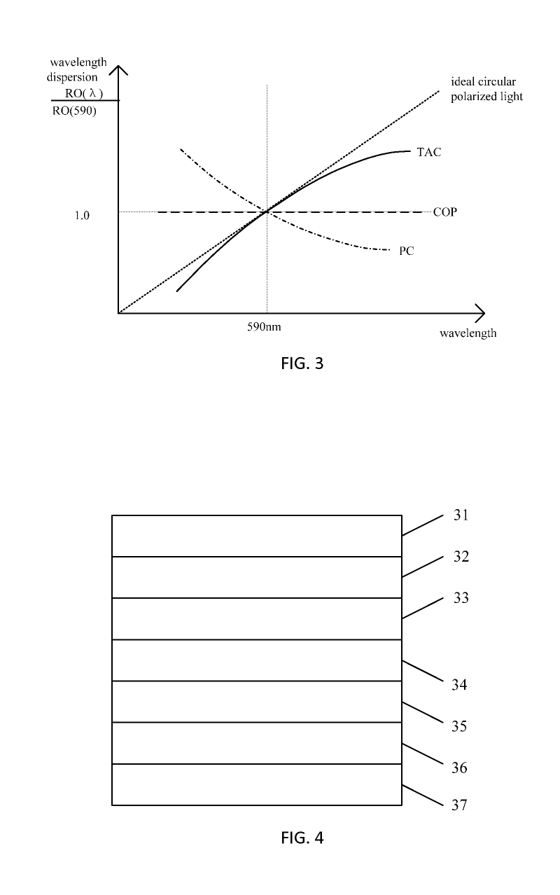

FIG. 3 is a schematic diagram of the wavelength dispersion of the different materials. As shown in FIG. 3, it can obtain the emitted light closer to the state of the circular polarized light by using TAC as the conversion layer 23.

Wherein, the material of the polarizing layer 22 is polyvinyl alcohol. Through the above description of the embodiment, it can be realized that the polarizing device using the conversion layer according to the present invention provides can transfer the linear polarized light of the polarizing device into the circularly polarized light or elliptically polarized light because the angle θ between the optical axis of the conversion layer and the polarization axis of the polarizing layer is n*90°+45°, wherein the n is an integer not less than zero. Through the above way, it is not necessary to provide a circularly polarized material with similar effect in addition to the existing polarizer, which can utilize the polarizing device to change the polarization state of the emitted light of LCD device with low costs, making it become the circularly polarized light or elliptically polarized light, and achieve the effect of protecting the human's eyes and simple structure. At the same time, the polarizing layer is located between the support layer and the conversion layer, so the conversion layer can also protect the polarizing layer. The present embodiment doesn't need to provide the circularly polarized material with similar effect in addition to the existing polarizer. Therefore, the LCD product utilizing the polarizing device according to the present invention can keep the thin structure, and there is no requirement to provide the circularly polarized material with similar effect in addition to the existing polarizer which results the complex processes, reducing the cost.

Referring to FIG. 4, FIG. 4 is a schematic structural diagram of the polarizing device another embodiment of according to the present invention. The polarizing device according to the present embodiment further comprises a surface treatment layer 32 used for anti-glare and anti-reflection in addition to the first support layer 35, the polarizing layer 34 and the conversion layer 33. The surface treatment layer 32 and the polarizing layer 34 are provided on the both side surfaces of the conversion layer 33. Wherein, the first support layer 35 can also be selected from a film with liquid crystal optical compensation after stretching, in order to achieve the optical compensation to the liquid crystal cell, further improving the display effect.

Moreover, the polarizing device according to the present embodiment further comprises a protective film 31. The protective film 31 and the conversion layer 33 are provided on the both side surfaces of the surface treatment layer 32. The protective film 31 can be peeled off when assembling the polarizing device.

Referring to FIG. 4, in order to achieve the bonding of the polarizing device with the liquid crystal cell, the polarizing device according to the present embodiment further comprises an adhesive layer 36 provided on the bottom layer of the first support layer 35, and, further comprises a release film 37 used to protect the adhesive layer 36. The adhesive layer 36 is provided between the first support layer 35 and the release film 37. The release film 37 can protect the adhesive layer 36, which can be peeled off when the polarizing device bonding to the liquid crystal cell.

Each embodiments of the polarizing device according to the present invention mentioned above could be the conversion layer instead of one of the two support layers of the polarizing film, that is omitting the corresponding support layer; of course, in the other embodiment, the polarizing device could comprise the conversion layer and both support layers at the same time, the polarizing layer and the conversion layer are located between the both support layers.

Basing on the above embodiment of the polarizing device, the present invention further provides a LCD device.

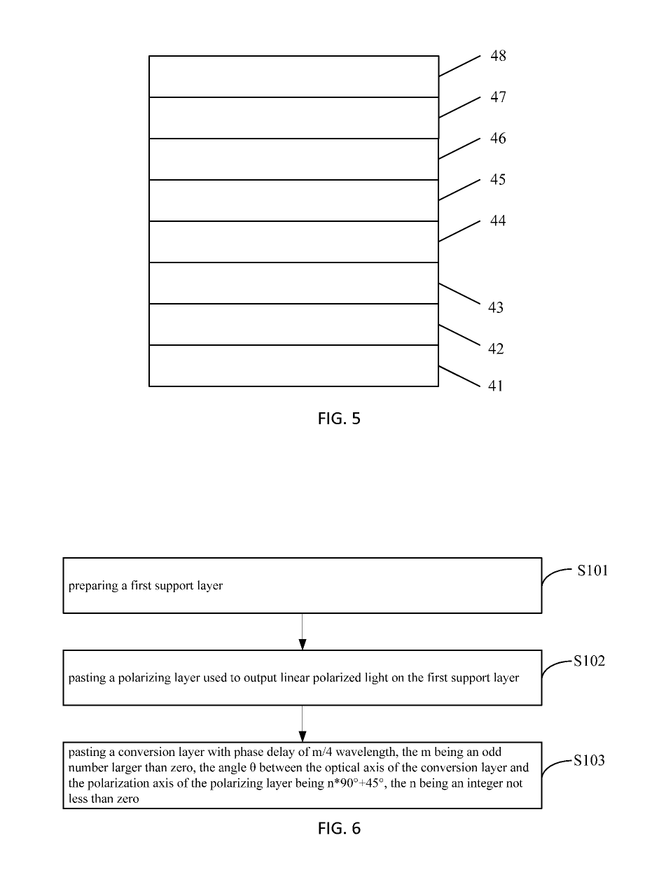

Referring to FIG. 5, FIG. 5 is a schematic structural diagram of the LCD device according to an embodiment of the present invention. As shown in FIG. 5, the LCD device comprises a liquid crystal cell 47 and the polarizing device 48 provided by any other embodiments mentioned above. The polarizing device 48 is provided at the emitting light side of the liquid crystal cell 47, and the conversion layer in the polarizing device is away from the liquid crystal cell 47 corresponding to the polarizing layer (each structural diagram of the polarizing device is not shown in figure). The positional relationship within each structural layer and the functions of each layer in the polarizing device according to the present embodiment are described as above embodiment, which is not repeated here.

Wherein, the emitting light side of the liquid crystal cell 47 of the LCD according to the present invention is also provided with a down polarizer. The down polarizer in the present embodiment comprises: a polarizing layer 43, inner and outer support layers 44, 42, an adhesive film 45, a release film 46 and a protective film 41. Same as the above description of embodiment, the release film 46 is used to protect the adhesive film 45, which can be peeled off while pasting the liquid crystal cell; the protective film 41 can be peeled off while assembling the modules.

The upper polarizing film of the LCD device according to the present invention is a polarizing device using a conversion layer. It is not necessary to provide a circularly polarized material with similar effect in addition to the existing polarizer, which can utilize the polarizing device to change the polarization state of the emitted light of LCD device with low costs, making it become the circularly polarized light or elliptically polarized light, and achieve the effect of protecting the human's eyes and simple structure. At the same time, the polarizing layer is located between the support layer and the conversion layer, so the conversion layer can also protect the polarizing layer. The LCD device utilizing the polarizing device according to the present invention can keep the thin structure, and there is no requirement to provide the circularly polarized material with similar effect in addition to the existing polarizer which results the complex processes, reducing the cost.

Referring to FIG. 6, FIG. 6 is a flowchart of the polarizing device manufacturing method according to an embodiment of the present invention, the manufacturing method of the polarizing device according to the present invention comprises:

Step S101: preparing a first support layer. The present embodiment adopts the materials with the compensating performance to obtain the first support layer, such as TAC, COP, PET, PMMA, liquid crystal, etc. Wherein, TAC material is preferably used to obtain the first support layer.

Step S102: pasting a polarizing layer used to output linear polarized light on the first support layer. Paste the polarizing layer on the first support layer. The polarizing layer is the core layer of the polarizing device, which can output the linear polarized light. The polarizing layer according to the present embodiment is made of the polyvinyl alcohol film after stained and stretched.

Step S103: pasting a conversion layer with phase delay of m/4 wavelength, the m being an odd number larger than zero, the angle θ between the optical axis of the conversion layer and the polarization axis of the polarizing layer being n*90°+45°, the n being an integer not less than zero. Paste a conversion layer on the polarizing layer. The conversion is used to transfer the linear polarized light, which is output by the polarizing layer, into circularly polarized light or elliptically polarized light. At the same time, in the present embodiment, the conversion is also as the second support layer to cooperate with the first support layer to achieve the supporting effect, in order to isolate the water and the air and protect the polarizing layer.

Of course, the above steps are not strictly distinguished the sequence. In the actual application, the manufacturing steps can be adjusted according to the requirements, which only needs to sequentially stack the layers together according to the structure.

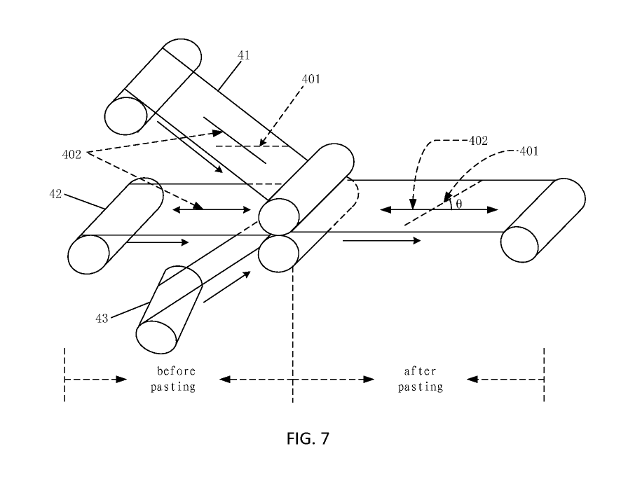

In the present embodiment, paste the conversion layer with the polarizing layer through roller and lamination, and make the angle θ between the optical axis of the conversion layer and the polarization axis of the polarizing layer be n*90°+45°, such as 45° or 135°, wherein the n is an integer not less than zero. Specifically, referring to FIG. 7, FIG. 7 is a schematic diagram of the bonding within the polarizing layer, the conversion layer and the first support layer, which achieves the pasting of the polarizing layer, the conversion layer and the first support layer through the roll-to-roll process. The middle-left one is the schematic diagram before pasting, the right one is the schematic diagram after pasting. Wherein, the conversion layer 41 and the first support layer 43 are respectively located on the both sides of the polarizing layer 42, the angle θ between the optical axis 401 of the conversion layer 41 and the polarization axis 402 of the polarizing layer 42 is n*90°+45°. Wherein, the angle θ is preferably 45° or 135°.

In the present embodiment, the material of the conversion layer is a material with phase delay of m/4 wavelength. The m is an odd number larger than zero, such as the m is 1, 3, 5, etc. For example, the material of the conversion layer may be TAG, COP, PET or PMMA, etc. Wherein, it is preferably to utilize the TAC to be the material of the conversion layer, because the wavelength dispersion ratio thereof is closer to the ideal circularly polarizing film, which can obtain the emitted light closer to the state of the circular polarized light.

In the present embodiment, it needs to be noted that the manufacturing method of the polarizing device according to the present invention further comprises providing the adhesive film on the bottom surface of the first support layer, in order to paste the polarizing device according to the present invention with the liquid crystal cell.

Basing on the above embodiment, the present invention also provides a manufacturing method of the LCD device, which comprises the step of manufacturing polarizing device mentioned in the above embodiment, and the step of pasting the manufactured polarizing device to the emitted light side of the liquid crystal cell.

Moreover, the manufacturing method of the LCD device further comprises the step of pasting the down polarizer to the emitted light side of the liquid crystal cell.

Through the above description of the embodiment, the present invention provides a polarizing device, a liquid crystal display device and a manufacturing method thereof. The polarizing device using the conversion layer is provided. Because the angle θ between the optical axis of the conversion layer and the polarization axis of the polarizing layer is n*90°+45°, wherein the n is an integer not less than zero, it can transfer the linear polarized light of the polarizing device into circularly polarized light or elliptically polarized light. Through the above way, it is not necessary to provide a circularly polarized material with similar effect in addition to the existing polarizer, which can utilize the polarizing device to change the polarization state of the emitted light of LCD device with low costs, making it become the circularly polarized light or elliptically polarized light, and achieve the effect of protecting the human's eyes and simple structure. At the same time, the polarizing layer is located between the support layer and the conversion layer, so the conversion layer can also protect the polarizing layer. The present embodiment doesn't need to provide the circularly polarized material with similar effect in addition to the existing polarizer. Therefore, the LCD product utilizing the polarizing device according to the present invention can keep the thin structure, and there is no requirement to provide the circularly polarized material with similar effect in addition to the existing polarizer which results the complex processes, reducing the cost.

The preferred embodiments according to the present invention are mentioned above, which cannot be used to define the scope of the right of the present invention. Those modifications and variations are considered encompassed in the scope of protection defined by the claims of the present invention.

What is claimed is:

1. A polarizing device, wherein, the polarizing device comprises: a first support layer, a polarizing layer used to output linear polarized light, and a conversion layer with phase delay of m/4 wavelength, the m being an odd number larger than zero, the first support layer, the polarizing layer, and the conversion layer being staked sequentially, the angle θ between the optical axis of the conversion layer and the polarization axis of the polarizing layer being n*90°+45°, the n being an integer not less than zero, the conversion layer being as a second support layer at the same time cooperating with the first supporting layer to support the polarizing layer: the polarizing device further comprising a surface treatment layer used for anti-glare and anti-reflection, the surface treatment layer and the polarizing layer being provided on the both side surfaces of the conversion layer.

2. The polarizing device as claimed in claim 1, wherein the material of the conversion layer is one of cellulose triacetate, cycloolefin polymer, polyethylene terephthalate, polycarbonate, or poly methyl methacrylate.

3. The polarizing device as claimed in claim 2, wherein the material of the polarizing layer is polyvinyl alcohol.

4. The polarizing device as claimed in claim 1, wherein it further comprises a protective film, the protective film and the conversion layer are provided on the both side surfaces of the surface treatment layer.

5. The polarizing device as claimed in claim 4, wherein it further comprises an adhesive layer and a release film, the adhesive layer is provided between the first support layer and the release film.

6. A liquid crystal display device, comprising: a liquid crystal cell and a polarizing device, the polarizing device being provided at the emitting light side of the liquid crystal cell, and the conversion layer being away from the liquid crystal cell corresponding to the polarizing layer, wherein, the polarizing device comprises: a first support layer, a polarizing layer used to output linear polarized light, and a conversion layer with phase delay of m/4 wavelength, the m being an odd number larger than zero, the first support layer, the polarizing layer, and the conversion layer being staked sequentially, the angle θ between the optical axis of the conversion layer and the polarization axis of the polarizing layer being n*90°+45°, the n being an integer not less than zero.

7. The liquid crystal display device as claimed in claim 6, wherein the conversion layer is as a second support layer at the same time cooperating with the first supporting layer to support the polarizing layer.

8. The liquid crystal display device as claimed in claim 7, wherein the material of the conversion layer is one of cellulose triacetate, cycloolefin polymer, polyethylene terephthalate, polycarbonate, or poly methyl methacrylate.

9. The liquid crystal display device as claimed in claim 6, wherein the polarizing device further comprises a surface treatment layer used for anti-glare and anti-reflection, the surface treatment layer and the polarizing layer is provided on the both side surfaces of the conversion layer.

10. The liquid crystal display device as claimed in claim 9, wherein the polarizing device further comprises a protective film, the protective film and the conversion layer are provided on the both side surfaces of the surface treatment layer.

11. The liquid crystal display device as claimed in claim 10, wherein the polarizing device further comprises an adhesive layer and a release film, the adhesive layer is provided between the first support layer and the release film.

12. The liquid crystal display device as claimed in claim 6, wherein the emitting light side of the liquid crystal cell is further provided with a down polarizer.

13. A manufacturing method of polarizing device, comprising:
preparing a first support layer;
pasting a polarizing layer used to output linear polarized light on the first support layer;
pasting a conversion layer with phase delay of m/4 wavelength, the m being an odd number larger than zero, the angle θ between the optical axis of the conversion layer and the polarization axis of the polarizing layer being n*90°+45°, the n being an integer not less than zero.

14. The manufacturing method as claimed in claim 13, wherein the conversion layer is cellulose triacetate layer, cycloolefin polymer layer, polyethylene terephthalate layer, polycarbonate layer, or poly methyl methacrylate layer after diagonally extending in odd multiple of 45°.
